(19) United States
(12) Patent Application Publication
(10) Pub. No.: US 2002/0059529 A1
(43) Pub. Date: May 16, 2002

(54) Email systems

(76) Inventors: Richard Beton, Romsey (GB); Robert Hancock, Southampton (GB)

Correspondence Address: CROWELL & MORING, L.L.P., P.O. Box 14300, Washington, DC, 20044-4300, US

(21) Appl. No.: 09/985,321

(22) Filed: Nov. 2, 2001

(30) Foreign Application Priority Data
Nov. 2, 2000 (GB) 0026764.1

(51) Int. Cl. H04L 9/00

(52) U.S. Cl. 713/201; 713/150

(57) ABSTRACT

A secure email system for pre-selected email users forming a participating user group requiring secure communication, comprising a secure list server to which all secure emails are sent by members of the participating user group, the server comprising a store for certification data and a CPU which compares the names of intended recipients of each email message with data in the store and processes the message to facilitate onward certificated transmission provided the recipient is duly certificated as indicated by data in the store.

This invention relates to email systems and more particularly it relates to secure email systems.

Secure email systems are designed to afford security of communication so that emailed information can be accessed by authorised persons only. Such systems are well known and normally comprise the use by each participating user of a unique certificate, which serves in effect as a key or password, to identify the user to other participating users of the system. Thus when sending a secure email message, the message must be appropriately certificated to enable a recipients to read it and to identify the sender.

Known secure email systems, although satisfactory for the provision of secure communication between the participants of small user groups, become somewhat cumbersome for larger groups, particularly when an email message must be sent by one group member to all other group members, because of the necessity for the sender to have certification data appertaining all intended email message recipients.

Moreover, the basic requirement for each group member to hold certification information appertaining to every other member of the group as a whole, apart from being cumbersome in use of the system, presents an obvious security risk in view of the large number of users required to store certification data. Additionally, in order to maintain security with changing user requirements, it is important that all users have a current user certification list which introduces further potential security problems associated with the data updating operations required to keep each user's certification list current.

It is an object of the present invention to provide an improved secure email communication system wherein the foregoing problems are largely obviated.

According to the present invention, a secure email system for pre-selected email users forming a participating user group requiring secure communication, comprises a secure list server to which all secure emails are sent by members of the participating user group, the server comprising a store for certification data and a CPU which compares the names of intended recipients of each email message with data in the store and processes the message to facilitate onward certificated transmission provided the recipient is duly certificated as indicated by data in the store.

Thus it will be appreciated that in operation of a system according to this invention, there is no need for a group member to be put in possession of certification information appertaining to any other group member since such information is required to be stored only in the list server and with this arrangement it will be apparent that the system is much simpler and less cumbersome to use and moreover much more secure.

One embodiment of the invention will now be described by way of example only with reference to the accompanying drawings, in which;

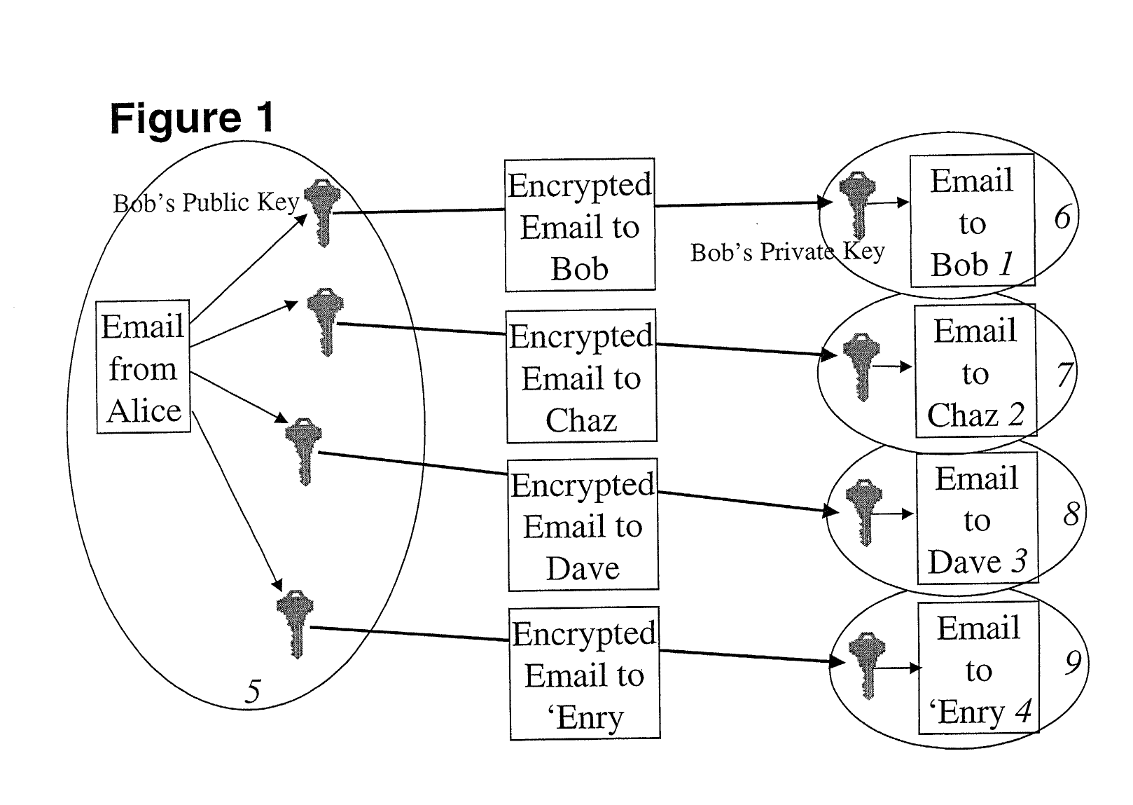

FIG. 1, is a schematic block/flow diagram of a known email system:

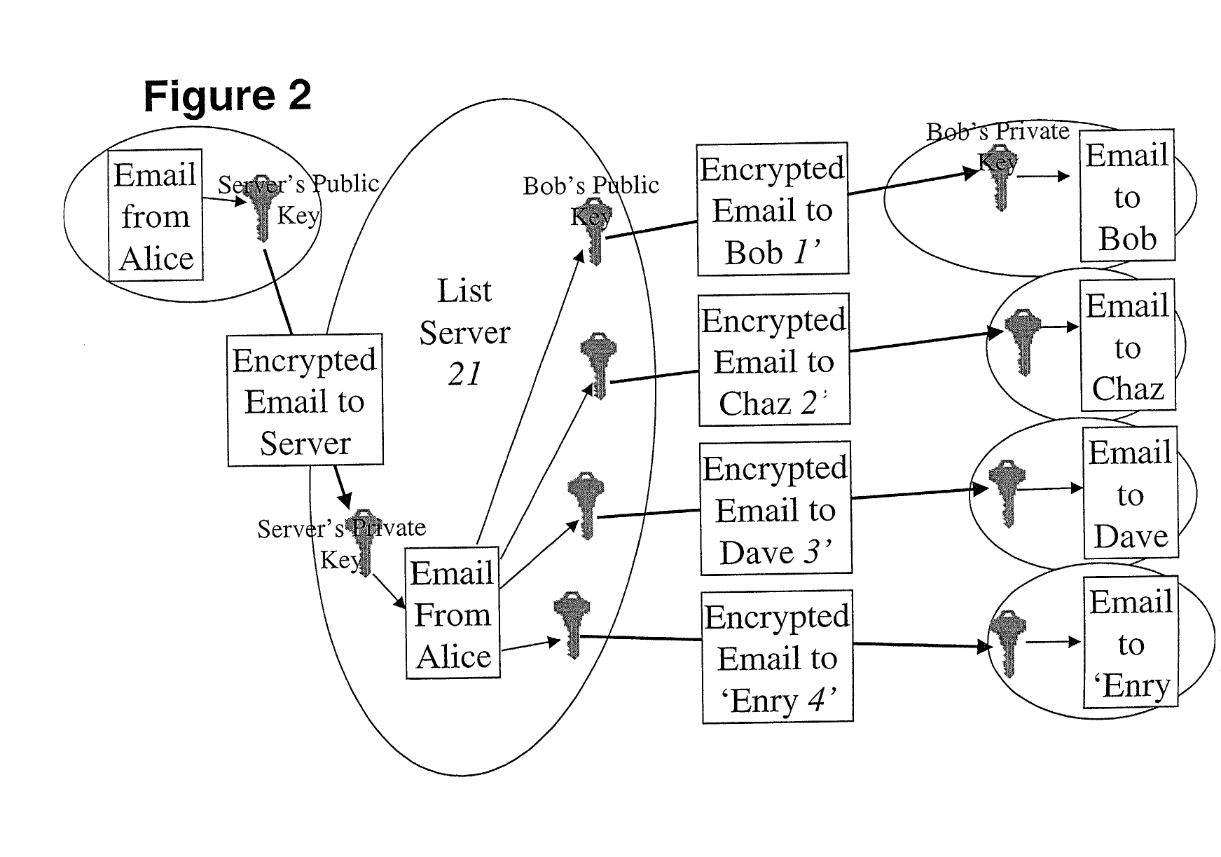

FIG. 2, is a schematic block/flow diagram of an email system comprising a encryption list server, and;

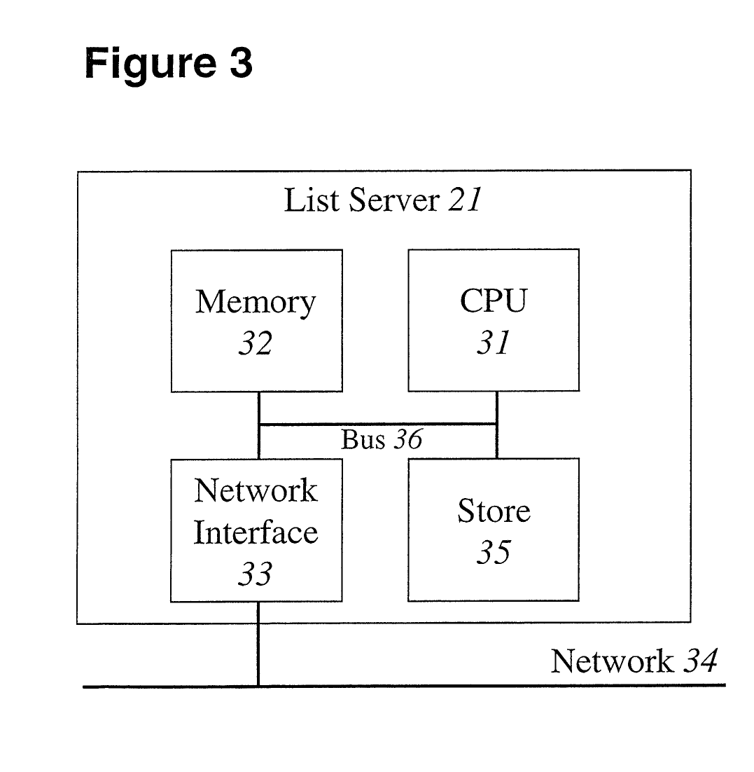

FIG. 3, is a schematic block diagram of a networked server and,

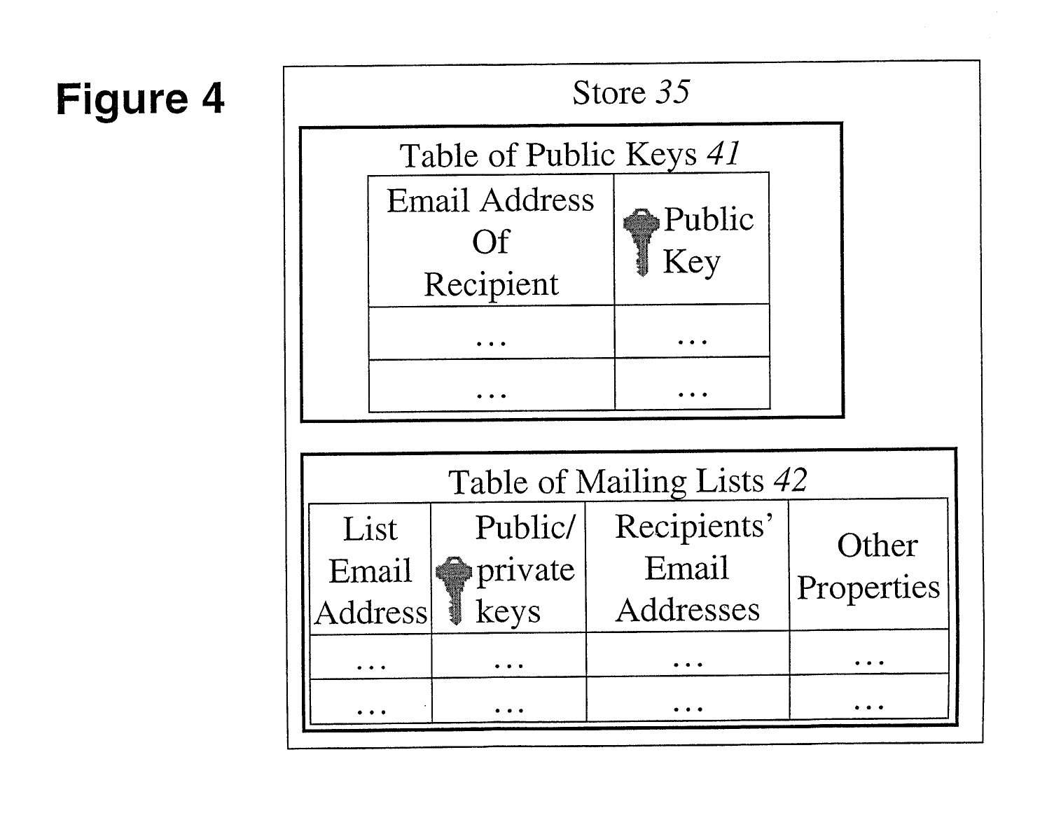

FIG. 4 is a representation of the key tables and mailing list tables required by the list server.

Referring now to FIG. 1, in a known secure email system which provides for secure communication between the members of a group comprising Alice, Bob, Chaz, Dave and 'Enry, it is apparent that if Alice wishes to send emails 1, 2, 3, and 4, from her work station 5, to Bob, Chaz, Dave and 'Enry respectively at their respective work stations 6, 7, 8 and 9, not only does she need to know the email address, of each recipient, but she also needs to know the certificate data or public key of each recipient. As hereinbefore explained, although this may be acceptable for communication between the members of a small secure group, it becomes inefficient and introduces potential security problems for larger groups.

Accordingly, in order to avoid these problems, a system as shown in FIG. 2, is proposed (wherein those parts shown also in FIG. 1, bear the same numerical designations) which system comprises a list server 21, via which all secure communications are transmitted. Thus with the system of FIG. 2, in order to send secure emails 1′, 2′, 3′ and 4′, to Bob, Chaz, Dave and 'Enry Alice needs only to know their respective email addresses and certificate data which defines the private key of the list server 121, certificate data defining the private keys of Bob, Chaz, Dave and 'Enry being stored only at the list server 21, and being appended in the list sever to messages for onward transmission to Bob, Chaz, Dave and 'Enry as appropriate.

As shown in FIG. 3, the list server 21 typically comprises a CPU 31, a memory 32 which may form a part of the CPU 31, and which carries programs in accordance with which the CPU 31, operates, a network interface 33, a store 35, and a bus 36, which conventionally serves for data transmission between the various parts of the list server 21.

The list server 21, is connected via a network 34, to other computers (not shown), from whence emails may originate or to which emails may be sent. The store 35, shown also in FIG. 4, contains a table of public keys 41, which is the certification data for all group members. This certification data is therefore easy to update since it is centrally located and provides better security than the known system of FIG. 1, wherein certification data is disparately located. If there is a need to support more than one mailing list forum on a single server, the store 35, may also contain in this case, a table of mailing lists 42. Each entry in the table of mailing lists will include information about a particular mailing list, comprising most notably its email address, together with the public key and private key which apply to that list, and the set of members of the list. This set of members, identifies who receives messages passed via the particular list. It may be expressed by the email addresses of the recipients or by another means. Also shown in FIG. 4, the table of mailing lists 42, may also be arranged to include data appertaining to other properties, which may or may not be present. This data might, for example, define policies for how people join lists.

In operation of the system of FIG. 2, when an incoming email message is received at the server 21, the CPU uses its private key to decrypt the message. The clear-text message is sent to all of the recipients of the list, in each case being encrypted using the public key of that recipient. The local clear-text copy of the message would normally be deleted.

One of the advantages of the system is that it lends itself to facilitating seamless inter-working between differing email encryption methods. For example, subscribers to a list server 21, could include people using PGP (Pretty Good Privacy) and also people using S/MIME (Secure Multipart Internet Mail Extensions). This is possible because each email passing through the list server 21, is decrypted to a clear-text form before being re-encrypted for each recipient. The re-encryption can therefore use the encryption method chosen by each recipient, on a person-by-person basis.

1. A secure email system for pre-selected email users forming a participating user group requiring secure communication, comprising a secure list server to which all secure emails are sent by members of the participating user group, the server comprising a store for certification data and a CPU which compares the names of intended recipients of each email message with data in the store and processes the message to facilitate onward certificated transmission provided the recipient is duly certificated as indicated by data in the store.

2. A secure email system as claimed in claim 1, the said certification store contains the email address of all user group members and the public key of each member.

3. A secure email system as claimed in claim 1, or claim 2, wherein the public key of each group member is based on the same coding system.

4. A secure email system as claimed in claim 1, or claim 2, wherein different coding systems are used for the public keys used by group members.

5. A secure email system as claimed in any preceding claim wherein the said store is arranged to contain a plurality of mailing lists, each of which appertains to different user group, whereby the use of one server for a plurality of disparate user groups is thereby facilitated.

6. A secure email system for pre-selected email users forming a participating user group requiring secure communication, as hereinbefore described with reference to the accompanying drawings.
